(19) United States
(12) Patent Application Publication
(10) Pub. No.: US 2020/0086708 A1
(43) Pub. Date: Mar. 19, 2020

(54) Bump Stop

(71) Applicant: William Cervantes, La Puente, CA (US)

(72) Inventor: William Cervantes, La Puente, CA (US)

(21) Appl. No.: 16/131,013

(22) Filed: Sep. 13, 2018

(51) Int. Cl. B60G 15/06; F16F 13/08; F16F 1/32

(52) U.S. Cl. CPC B60G 15/061; F16F 13/085; B60G 2204/4502; F16F 2224/048; F16F 2232/08; F16F 1/328

(57) ABSTRACT

Provided herein is a bump stop including a cylindrical body, a cylindrical shaft positioned within the cylindrical body and axially aligned with the cylindrical body, a top retainer and a bottom retainer each connected to an end of the cylindrical body. The cylindrical shaft protrudes through the bottom retainer. A spring is connected to one end of the cylindrical shaft and is connected to the top retainer. A shear thickening fluid disposed in the cylindrical body, between the cylindrical body and the cylindrical shaft. The cylindrical shaft includes an obstruction perpendicular to an axis of the cylindrical shaft, and the obstruction and the shear thickening fluid affect control of movement of the cylindrical shaft under impact.

### FIELD

The disclosure herein relates to bump stops (also referred to as “bumpshocks”) used conventionally, among other things, for off-road applications of motor vehicles.

### BACKGROUND

Motor vehicle suspension systems can be configured so that the wheels are able to navigate elevational changes in the road surface as the vehicle travels. In either jounce or rebound, a spring (e.g., coil, leaf, torsion, etc.) is incorporated at the wheel in order to provide a resilient response to respective vertical movements with regard to a frame of the vehicle. However, a shock absorber can be placed at the wheel to dampen wheel bounce in order to prevent wheel bouncing and excessive vehicle body motion. Additionally, a maximum jounce impact absorber can be provided in the form of a bump cushion or bump stop.

One purpose of a bump stop is to prevent over travel of the suspension so it does not bottom out the car. More specifically, the bump stop can serve as a final suspension cushion (also called a soft stop) to keep the metal parts from coming together, which may in some way damage the suspension or chassis. Two known types of bump stops are fixed-element stops and valve stops that use a compressed-gas cylinder.

Fixed-element stops can be made of rubber or polyurethane. These stops supplement the final portion of spring travel with a high rate spring constant inherent to the bump stop. Additionally, fixed-element stops can be tapered in shape which can provide somewhat of a progressive increase in spring rate as the bump stop is compressed.

One downside to a rubber or polyurethane bump stop is that they can dissipate energy into the suspension rebound, which can cause the shock absorber to work harder. These bump stops offer little damping and often behave much like a pure coil spring.

Gas pressurized nitrogen bump stops (also called air bumps or hydraulic bump stops) may also play a component of a performance suspension system. These bumps consist of a short stroke shock mechanism. Oil is used inside and moves through orifices much like a standard shock. Air-bumps can protect the vehicle and suspension components from hard bottom-outs, and can play a role in end-stroke damping.

### BRIEF DESCRIPTION OF THE DRAWINGS

The embodiments herein are illustrated by way of example and not by way of limitation in the figures of the accompanying drawings in which like references indicate similar elements. It should be noted that references to “an” or “one” embodiment of the disclosure are not necessarily to the same embodiment, and they mean at least one. Also, in the interest of conciseness and reducing the total number of figures, a given figure may be used to illustrate the features of more than one embodiment of the disclosure, and not all elements in the figure may be required for a given embodiment.

FIG. 1 illustrates a representational view of a bump stop, according to a first example embodiment.

FIG. 2 illustrates a side view of the bump stop shown in FIG. 1, according to the first example embodiment.

FIG. 3 illustrates a sectional view of the bump stop shown in FIG. 1, according to the first example embodiment.

FIG. 4 illustrates a top view of the bump stop shown in FIG. 1, according to the first example embodiment.

FIG. 5 illustrates a side view of a bump stop, according to a second example embodiment.

FIG. 6 illustrates a sectional view of the bump stop shown in FIG. 5, according to the second example embodiment.

FIG. 7 illustrates an exploded view of the bump stop shown in FIG. 5, according to the second example embodiment.

### DETAILED DESCRIPTION

Various embodiments and aspects of the disclosure herein will be described with reference to details discussed below, and the accompanying figures will illustrate the various embodiments. The following description and figures are illustrative of the disclosure herein and are not to be construed as limiting. Numerous specific details are described to provide a thorough understanding of various embodiments. However, it is understood that embodiments disclosed herein may be practiced without these specific details. In certain instances, well-known or conventional details, such as structures and techniques, are not described in order to provide a concise discussion of example embodiments.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Rock crawling is an extreme form of off road driving using vehicles anywhere from stock to highly modified to overcome obstacles. In rock crawling, drivers drive highly modified four-wheel-drive vehicles over very harsh terrain. Driving locations include boulders, mountain foothills, rock piles, mountain trails, etc. Rock crawling is about slow-speed, careful and precise driving, and high torque generated through large gear reductions in the vehicles drivetrain.

The inventor herein has recognized that rubber or polyurethane bump stops used on vehicles in rock-crawling are typically around 4″ and typically cannot compress any shorter. This limitation in compression can decrease wheel travel for going over rocks and can therefore impede performance of the vehicle while rock-crawling. Furthermore, the inventor herein has recognized that air bumps are typically limited to only working to dampen the bump.

According to one aspect of the disclosure herein, a bump stop includes a cylindrical body and a cylindrical shaft positioned within the cylindrical body. The cylindrical shaft is axially aligned with the cylindrical body. The bump stop further includes a top retainer and a bottom retainer each connected to an end of the cylindrical body. The cylindrical shaft protrudes from inside the body, through the bottom retainer, and external the body. The bump stop further includes a spring connected to one end of the cylindrical shaft. The spring is connected to the top retainer. The bump stop also includes a shear thickening fluid disposed in the cylindrical body between the cylindrical body and the cylindrical shaft. The cylindrical shaft may include an obstruction perpendicular to an axis of the cylindrical shaft. The obstruction and the shear thickening fluid together affect movement of the cylindrical shaft under impact. The effect of movement can be through a mechanical passive control system. The system can be driven by the dashpot Principles. Unlike an electrical control system which may require a sensor, the disclosed bump stop merely utilizes an input (e.g., the bump) to respond. The controlled movement of the shaft is longitudinal to the axis of the body and shaft. In some instances, the obstruction and the shear thickening fluid affect the cylindrical shaft to have little or zero movement under high impulse. In other instances, the obstruction and the shear thickening fluid affect the cylindrical shaft to move in a direction toward the top retainer under low impulse. As background, a dashpot is a mechanical device or a damper which resists motion via viscous friction. The resulting force is proportional to the velocity, but acts in the opposite direction, slowing the motion and absorbing energy. It is commonly used in conjunction with a spring which acts to resist displacement. However, with an STF (Shear thickening Fluid) the force is not proportional to velocity, but is rather a differential rate with respect to a function as described and shown in more detail below.

Generally, the foregoing described bump stop can be used as a hydraulic dampening system for off-road vehicles, and more particularly, rock-crawling vehicles for high clearances of rocks. By virtue of the foregoing disclosed arrangement, the bump stop can work dynamically in different load-case scenarios. For example, the bump stop can act as a solid (e.g., hard stop) under high impulse (e.g., High force, short time duration), and can compress under low impulse (e.g., Medium Force, long time duration) which allows optimal wheel travel or at least clearance over higher rocks.

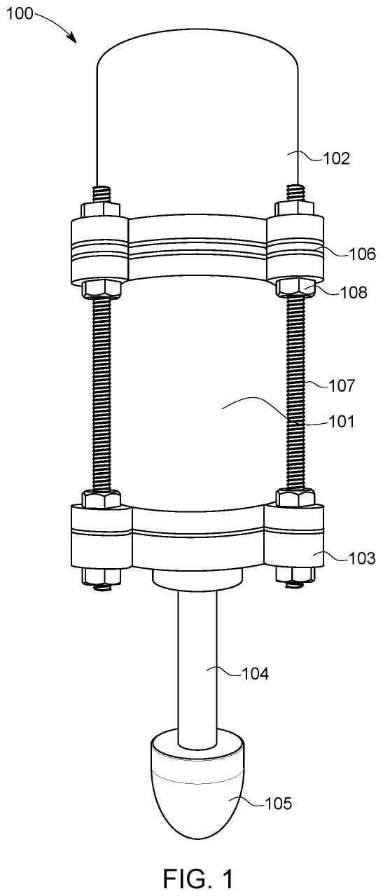

Turning to FIG. 1, FIG. 1 depicts a representational view of a bump stop 100, according to a first example embodiment. As shown in FIG. 1, the bump stop 100 is constructed of a housing or body 101 with a top retainer 102 connected to one end of the body 101 and a bottom retainer 103 connected to the other end of the body 101. At the end of the body 101 having the bottom retainer 103, a rod or shaft 104 protrudes through the bottom retainer 103 and extends beyond the body 101. At an end of the shaft 104 directed away from the bump stop 100 connected to the shaft 104 is a bumper 105. The bumper 105 may be made of rubber to protect against metal-to-metal contact, and may be molded or screwed onto the shaft 104. In an example application of the bump stop in a suspension system of a vehicle, the top retainer may attach or connect to the undercarriage of the vehicle while the shaft points in a downward direction toward the ground. The shaft therefore receives impact caused by compression of the suspension system of the vehicle due to uneven terrain underneath the vehicle.

The body 101 is shown in FIG. 1 as cylindrical; however, in other embodiments, the body may be in the form of a polyhedron or other shape and is not limited thereto. The body 101 may be constructed of a high strength polyurethane or metal material. For example, the body can be machined out of 6061-T6 Aluminum for lightweight and strength. In one instance, the body may be around 2″ in circumference and around 4″ in length from end to end. In one example, in an off-road version, the volume of the body can be around 2.3″×2.3″×6.5″. In another example, for smaller loads, the volume of the body can be around 1.5″×1″×1.75″. Of course, the body is not limited herein to these materials and dimensions; in other embodiments, the body may have different sizes and may be constructed of different materials.

The top retainer 102 may be affixed to the body 101 by bolt and screw 108, 107 or weld (not shown), and may be affixed to the underneath of a vehicle (not shown) by bolt or weld (not shown). The top retainer 102 may be constructed of a high strength polyurethane or metal. The bottom retainer 103 may also be affixed to the body 101 by bolt and screw 108, 107 or weld (not shown), and may also be constructed of high strength polyurethane or metal.

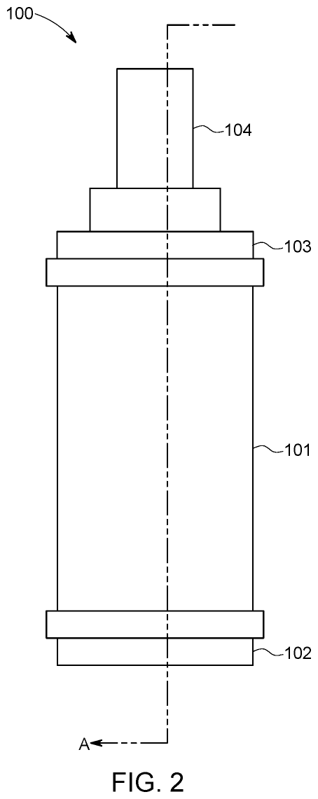

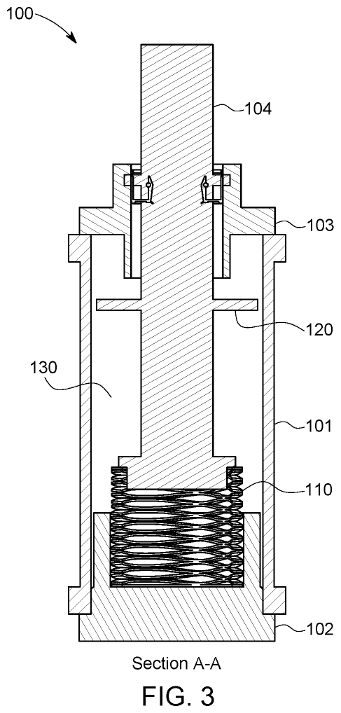

FIG. 2 illustrates a side view of the bump stop 100 shown in FIG. 1. As shown in FIG. 2, the bump stop 100 is structured, from top of the figure to the bottom, with the shaft 104 protruding from the bottom retainer 103 which is connected to the body 101 which is connected to the top retainer 102. The shaft 104 may retreat into the bump stop 100 through the bottom retainer 103 and into the body 101 upon impact, and may restore position by a spring (not shown in FIG. 2) to its original position after impact, which is described in more detail below in connection with FIG. 3.

FIG. 3 illustrates a sectional view of the bump stop shown in FIG. 2. As shown in FIG. 3, the bottom retainer 103 includes a cutout or opening central to an axis of the bottom retainer 103. The opening provides a path or guide for longitudinal movement of the shaft 104 which is described in more detail below. The bottom retainer further includes an oil-resistant shaft seal 109 that is provided in the opening of the bottom retainer 103, between the shaft 104 and the bottom retainer 103.

As further shown in FIG. 3, the shaft 104 is provided inside the body 101 of the bump stop 100. One end of the shaft 104 is affixed to a spring 110 which is affixed to the top retainer 102. The other end of the shaft 104 protrudes through the opening of the bottom retainer 103. A central axis of the shaft 104 aligns with a central axis of the body 101 and bottom retainer 103. The spring 110 may be a helical compression spring or a Crest-to-Crest® Wave Spring.

The shaft 104 may be cylindrical in shape; however, the shaft 104 is not limited to such, and in other embodiments, the shaft can be in the form of other shapes. The shaft 104 may be constructed of a metal material such as a stainless steel. For example, the shaft can be constructed out of a steel body for impact resistance which it may endure during a high load of a rock crawler. In other embodiments, the shaft may be constructed of another material such as rubber or polyurethane. A circumference of the shaft 104 may be a size such that the shaft has a running fit through the opening in the bottom retainer 104. A length of the shaft 104 may be long enough such that the shaft 104 protrudes externally from the body 101 with and without force on the shaft 104. In one example, the shaft size can be around 0.75″ in diameter and around 4″ in length.

As shown in FIG. 3, the shaft 104 includes an obstruction or interference 120. The obstruction 120 may be formed substantially perpendicular or normal to the axis of the shaft 104. The obstruction 120 may be, for example, in the shape of a disc. The obstruction 120 may be an extrusion from the shaft 104 in the form of a solid disc, which can include one or two or more extrusions. In this embodiment, the obstruction is positioned roughly half way down the shaft 104 so as to be substantially in the middle of the shaft 104. A length of the cylindrical body 101 is more than half the length of the cylindrical shaft 104. While one obstruction is illustrated in this embodiment, in other embodiments, there can be more than one obstruction extruded from the shaft such as two or more.

A non-Newtonian fluid 130 is disposed between the body 101 and shaft 104, and between the top and bottom retainers 102, 103. The fluid 130 may be, for example, a dilatant or shear thickening material in which viscosity increases with the rate of shear strain such as a shear thickening fluid. In particular, a dilatant is a Non-Newtonian fluid where the shear viscosity increases with applied shear stress. This behavior is only one type of deviation from Newton's Law, and it is controlled by such factors as particle size, shape, and distribution. Shear thickening behavior occurs when a colloidal suspension transitions from a stable state to a state of flocculation. A large portion of the properties of these systems are due to the surface chemistry of particles in dispersion, known as colloids.

One example fluid is a mixture of cornstarch and water (sometimes called oobleck), which acts in counterintuitive ways when struck or thrown against a surface. Another example fluid as a dilatant material is sand that is completely soaked with water. Yet another example fluid as a dilatant material is silica nano-particles dispersed in a solution of polyethylene glycol. The silica particles can provide a high strength material when flocculation occurs.

The shear thickening behavior occurs when, as the shear rate is increased, the viscosity of the system also increases. This behavior is observed because the system crystallizes under stress and behaves more like a solid than a solution. Thus, the viscosity of a shear-thickening fluid is dependent on the shear rate. See, for example, chart 1 below.

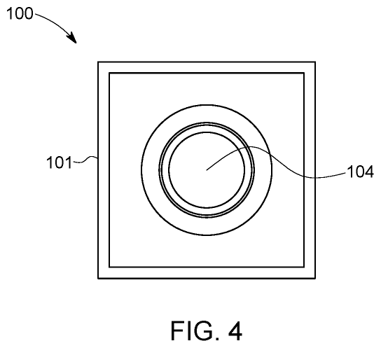

FIG. 4 illustrates a top view of the bump stop 100 shown in FIGS. 1-3, with the body 101 and shaft 104 protruding in a direction outward from the page. As shown in FIG. 4, the shaft 104 is roughly half the diameter of the body 101 providing a slender bump stop having a small footprint.

When in use, the bump stop can survive different levels of impact having different measures of impulse. Under a high impulse, the bump stop acts as a solid. In particular, under a high impulse (e.g., high force, short time duration), the obstruction and the friction along the shaft together with the fluid undergo an increased shear rate thereby increasing the viscosity of the fluid causing little to no movement of the shaft. An example of a high impulse is the vehicle falling off of a ledge. This can allow, for example, around 4″ of wheel travel. This can stop wheel travel, for example, 4″ before maximum compression.

On the other hand, when the bump stop is under a low impulse (e.g., medium force, long time duration), the obstruction and the friction along the shaft together with fluid undergo a decreased shear rate thereby decreasing the viscosity of the fluid allowing the shaft to travel into the body shortening the bump stop. An example of a low impulse is traveling, for example, over higher rocks. This would allow, for example, around 1.5″ to 3″ of wheel travel over the higher rocks (e.g., slow rock-crawling).

The foregoing situations illustrate how the obstruction together with the non-Newtonian fluid affect control of movement of the shaft based on a received impulse.

Impulse can be determined by equation 1 below.

$$Equation 1$$

$$\begin{matrix}\begin{matrix}Impulse = \\ Reduce average\end{matrix} \\ impact force\end{matrix} ↓ {F}_{average} Δ t \begin{matrix}↑ \begin{matrix}\begin{matrix}Extend time of collision \\ = m Δ v\end{matrix} \\ For a given change\end{matrix} \\ in momentum , the \\ impulse stays constant .\end{matrix} ,$$

F for force, t for time, m for mass and v for velocity. Example impulses with example forces and times are provided below in Table 1. In Table 1, F is calculated using an average car weight of 2,500 lbs (907 kg). Using gravity as acceleration at 9.82 m/s², F is calculated as 8906N using the second law of motion (i.e., F=ma).

TABLE 1

| | | Force | Impulse |
|---|---|---|---|
| | Time (s) | (N) | (N-s) |
| High Impulse | 0.1 | 8906 | 890.7 |
| Medium Impulse | 1 | 8906 | 8906 |
| Low Impulse | 10 | 8906 | 89067 |

For a high impulse, there is a shorter amount of time to dissipate energy. For a medium impulse, an object coming into contact with the bump stop may have more give or slack. In this case, the material may be softer and less stiff. For low impulse, the energy can have time to dissipate throughout the interaction of the forces.

By virtue of the foregoing disclosed arrangements, it is possible to provide a bump stop that provides for a rigid protection of the undercarriage of a vehicle under high impulses, while allowing for maximum clearance of wheel travel over higher rocks under low impulses.

Furthermore, conventional bump stops such as air shocks typically include a flow of fluid in and out of the bump stop using, for example, an external vacuum. As reflected in FIGS. 1-4, the bump stop 100 is self-contained such that the fluid 130 does not enter or exit the bump stop during operation. This can provide the advantageous effect of providing a closed system bump stop which can result in less failures and less maintenance and repair than conventional bump stops.

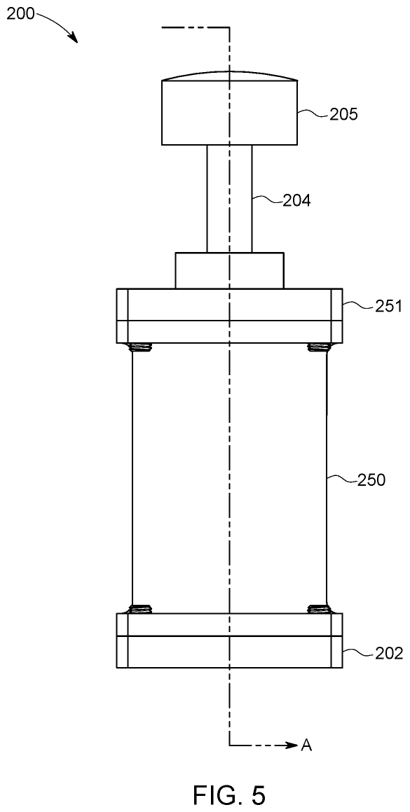

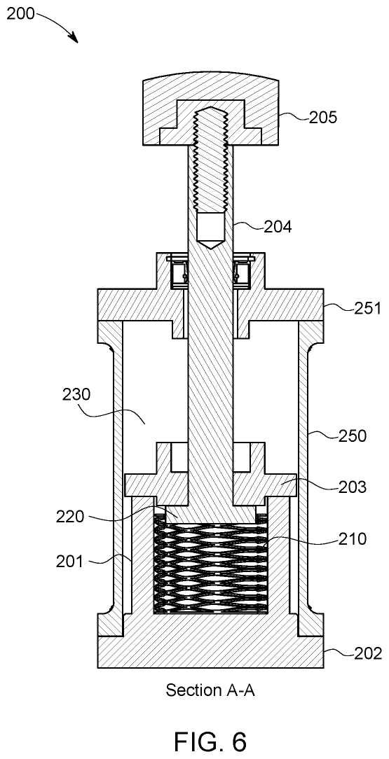

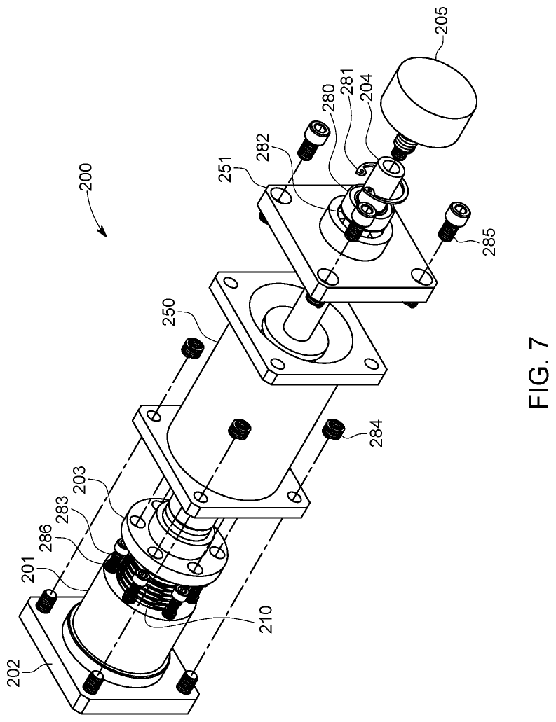

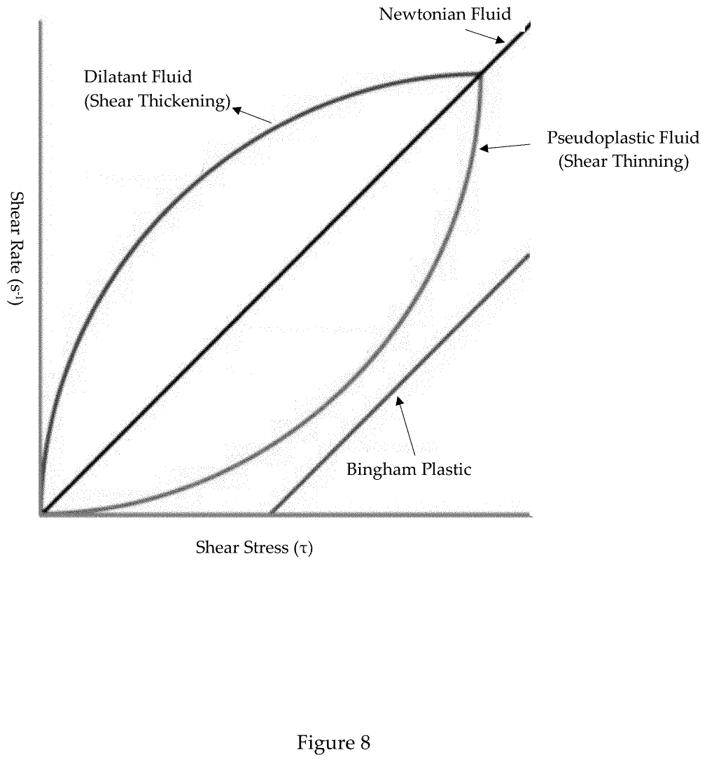

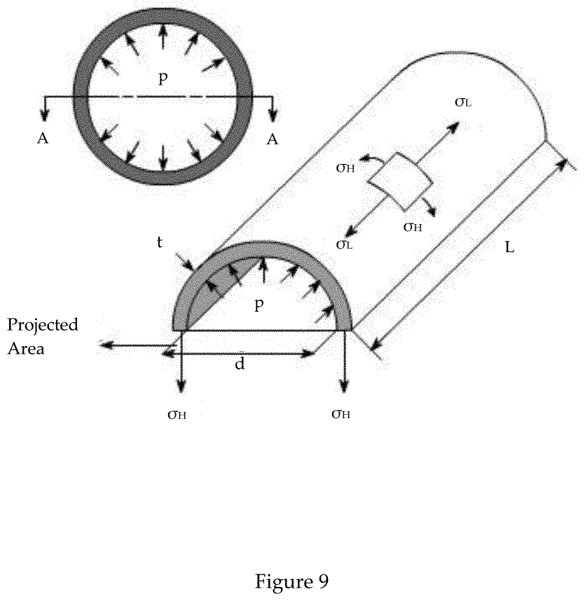

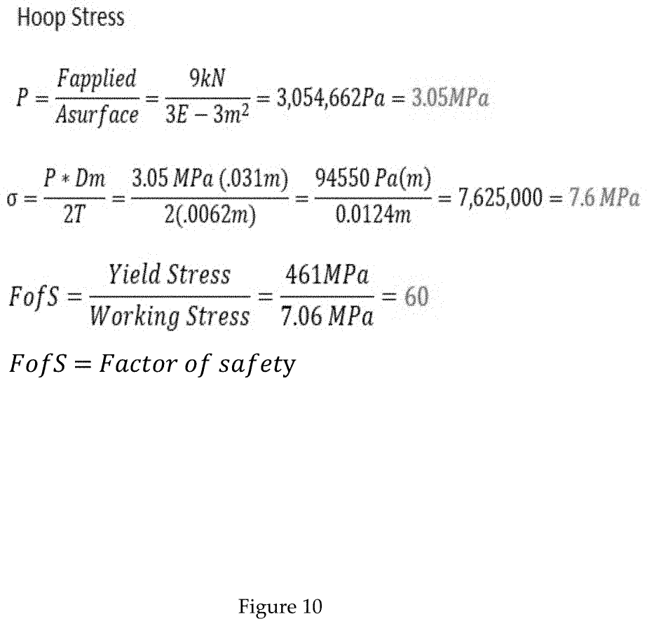

FIG. 5 illustrates a side view of a bump stop 200, according to a second example embodiment. The second example embodiment includes many similarities to the first example embodiment, but with some structural differences. In particular, as shown in FIG. 5, the bump stop 200 includes a housing 250, a top retainer 202, a shaft alignment 251, a shaft 204 and a rubber bumper 205. The top retainer 202 is connected to the housing 250, the housing 250 is connected to the shaft alignment 251, and the shaft 204 with bumper 205 a portion of which disposed and connected to the inside of housing 250. The connections between the components of bump stop 200 are described in detail below in connection with FIGS. 6 and 7. The housing can be formed of a metal material such as aluminum.

FIG. 6 illustrates a sectional view showing the inner workings of the bump stop 200 shown in FIG. 5. As shown in FIG. 6, in the second example embodiment, the bump stop 200 further includes a body 201, a bottom retainer 203, a spring 210 and a non-Newtonian fluid 230 provided in the body 201 between the top retainer 202 and the bottom retainer 203. The body 201 may be formed of a metal material such as steel. Attached to the shaft 204 is a bumper 205. The bumper 205 may be rubber or another material. The bumper 205 may be connected to the shaft 204 by a screw mechanism. In other embodiments, the bumper 205 may be formed to the shaft 204 or connected to the shaft 204 by another mechanism.

In the second example embodiment, the top retainer 202 and bottom retainer 203 are formed as one steel body. However, in other embodiments, the top retainer 202 and bottom retainer 201 can be separate components.

The shaft 204 includes an obstruction 220 positioned at the end of the shaft 204 closest to the top retainer 202 and within the spring 210. In this embodiment, the top retainer 202, bottom retainer 203 and body 201 holding the spring 210 are housed inside the housing 250. The shaft alignment 251 provides structural support for the shaft 204 and is attached to the housing 250 to increase the rigidity of the bump stop 200. The shaft 204 is loaded against the spring 210 until a force acts on the shaft 204. In the second embodiment, a length of the body 201 is less than half the length of the shaft 204.

FIG. 7 illustrates an exploded view of a more detailed construction of the bump stop 200 shown in FIG. 5. As shown in FIG. 7, the top retainer 202 and body 201 connect to the housing 250 via four (4) bolts 287 and four (4) helical inserts 284. The top retainer 203 connects to the body 201 via six (6) helical inserts 286 and six (6) socket head cap screws. The housing retainer 251 connects to the housing 250 via four (4) helical inserts 288 and four (4) steel socket head cap screws 285. The shaft 204 is inserted through and axially aligned with the top retainer 202, the body 201, the bottom retainer 203, the housing 250 and the housing retainer 251. The bumper 205 may include a threaded stud which is used to connect the bumper 205 to the shaft 204. An oil resistant shaft seal 280 and internal retaining ring 281 are provided around the shaft 204 between the housing retainer 251 and the bumper 205.

Similar to the bump stop disclosed in the first embodiment, when in use, the bump stop 200 can receive different levels of impact having different measures of impulse. Under a high impulse, the bump stop acts as a solid. On the other hand, when the bump stop is under a low impulse, the obstruction and the friction along the shaft together with fluid undergo a decreased shear rate thereby decreasing the viscosity of the fluid allowing the shaft to travel into the body shortening the bump stop. The foregoing situations illustrate how the obstruction together with the non-Newtonian fluid affect control of movement of the shaft based on a received impulse.

By virtue of the foregoing disclosed arrangements, it is possible to provide a bump stop that provides for a rigid protection of the undercarriage of a vehicle under high impulses, while allowing for maximum clearance of wheel travel over higher rocks under low impulses. Furthermore, the arrangement of the body and top retainer provide greater robustness and allows for less leaking of the fluid.

In one example, a free length of the spring can be around 2.0″ and the compressed length can be around 1.103″. In this example, a total travel distance of the spring is around 0.897″. See, for example, Table 2 below for different example travel distances for the spring under different levels of impulse.

TABLE 2

| | | | | Fast Stop |
|---|---|---|---|---|
| | Time | Force | Impulse | Distance |
| | (s) | (N) | (N-s) | (in.) |
| High Impulse | 0.1 | 8906 | 890.7 | 0 |
| Medium Impulse | 1 | 8906 | 8906 | 0.3 |
| Low Impulse | 10 | 8906 | 89067 | 0.89 |

The inventor herein performed a stress analysis on the bump stop disclosed herein in the second example embodiment. In general, hoop stresses are caused by increases of internal pressure of a thin-walled vessel. When the mechanism actuates, it will stress the inside of the stainless steel walls.

Chart 2 and Equation 2 shown below provide the basis for the analysis.

$$\begin{matrix}{σ}_{H} = Hoop Stress = Casing Tension = \frac{Force}{Area} = \frac{F}{A} \\ {σ}_{H} = \frac{F}{A} = \frac{Pressure \times Mean Diameter \times Length}{2 \times Wall Thickness \times Length} = \frac{{PD}_{m} L}{2 TL} & Equation 2 \\ {σ}_{H} = \frac{{PD}_{m} L}{2 TL} = \frac{{PD}_{m}}{2 T} & \\ {σ}_{H} = \frac{{PD}_{m}}{2} & \end{matrix}$$

Provided below are the results of the simulation. The simulation was performed using Stainless Steel Housing Spec to AISI 301 per MIL-S-5059 for strength properties, resulting in 67 Ksi=461 MPa.

$$Hoop Stress$$

$$P = \frac{Fapplied}{Asurface} = \frac{9 kN}{3 E - 3 {m}^{2}} = 3 \text{,} 054 \text{,} 662 Pa = 3.05 MPa$$

$$σ = \frac{P * Dm}{2 T} = \frac{3.05 MPa ( .031 m )}{2 ( .0062 m )} = \frac{94550 Pa ( m )}{0.0124 m} = 7 \text{,} 625 \text{,} 000 = 7.6 MPa$$

$$F of S = \frac{Yield Stress}{Working Stress} = \frac{461 MPa}{7.06 MPa} = 60$$

$$F of S = Factor of safety$$

The results of the analysis show the disclosed bump stop having a Factor of Safety of 60, which can provide a sturdy and wear-resistant bump stop.

While the disclosure herein has been provided with a focus on use in suspension systems for off-roading vehicles, other applications of the bump stop are envisioned by the inventor and can be implemented. As one example, the bump stop may be used in industrial manufacturing such as die stamping, as a safety mechanism for protection of operators' hands and limbs. Generally, the bump stop disclosed herein may be implemented in any machinery or system with a need for protection of the machinery or users of the machinery.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the disclosure herein, aspects of which are defined in the claims. Furthermore, different aspects of one embodiment herein may be applied to or combined with other embodiments herein.

What is claimed is:

1. A bump stop comprising:
a cylindrical body;
a cylindrical shaft positioned within the cylindrical body and axially aligned with the cylindrical body;
a top retainer and a bottom retainer each connected to an end of the cylindrical body, the cylindrical shaft protruding through the bottom retainer;
a spring connected to one end of the cylindrical shaft and connected to the top retainer; and
a shear thickening fluid disposed in the cylindrical body, between the cylindrical body and the cylindrical shaft,
wherein the cylindrical shaft includes an obstruction perpendicular to an axis of the cylindrical shaft, the obstruction and the shear thickening fluid affecting movement of the cylindrical shaft under impact.

2. The bump stop according to claim 1, wherein the obstruction and the shear thickening fluid control the cylindrical shaft to have little or zero movement under high impulse.

3. The bump stop according to claim 1, wherein the obstruction and the shear thickening fluid control the cylindrical shaft to move toward the top retainer under low impulse.

4. The bump stop according to claim 1, wherein the shear thickening fluid is self-contained within the bump stop.

5. The bump stop according to claim 1, wherein a length of the cylindrical body is more than half the length of the cylindrical shaft.

6. The bump stop according to claim 1, wherein a length of the cylindrical body is less than half the length of the cylindrical shaft.

7. The bump stop according to claim 6, wherein the bump stop further comprises an external body disposed around the cylindrical body and axially aligned with the cylindrical body, the external body providing structural support for a portion of the cylindrical shaft protruding through the bottom retainer.

8. The bump stop according to claim 1, wherein the obstruction is disposed substantially in the middle of the cylindrical shaft.

9. The bump stop according to claim 1, wherein the obstruction is disposed at one end of the cylindrical shaft.

10. The bump stop according to claim 1, wherein the bump stop is included in a hydraulic dampening system included in an undercarriage of a vehicle.

11. The bump stop according to claim 1, wherein the bump stop is included in a safety system of a manufacturing device.

12. The bump stop according to claim 1, wherein the bump stop further comprises a bumper disposed at an end of the shaft.

13. A bump stop comprising:
a body;
a shaft positioned within the body; and
a shear thickening fluid disposed in the body, between the body and the shaft,
wherein the shaft includes an obstruction, the obstruction being disposed in the shear thickening fluid.

14. A method of using a bump stop, the bump stop comprising a cylindrical body, a cylindrical shaft positioned within the cylindrical body, a top retainer and a bottom retainer each connected to an end of the cylindrical body, a spring connected to one end of the cylindrical shaft and connected to the top retainer, and a shear thickening fluid disposed in the cylindrical body, between the cylindrical body and the cylindrical shaft, the method comprising:
receiving an impact on an end of the cylindrical shaft; and
affecting movement of the cylindrical shaft using an obstruction disposed substantially perpendicular to an axis of the cylindrical shaft.

15. The method according to claim 14, wherein the received impact has a high impulse, and the cylindrical shaft is controlled to have little or zero movement.

16. The method according to claim 14, wherein the received impact has a low impulse, and the cylindrical shaft is controlled to move toward the top retainer.
